(19) United States
(12) Patent Application Publication
(10) Pub. No.: US 2009/0165732 A1
(43) Pub. Date: Jul. 2, 2009

(54) Ultraviolet light-reflecting collar for cats for deterring predation on birds

(76) Inventor: Linda Sue Farley, Laguna Beach, CA (US)

Correspondence Address: Linda S. Farley, 9 McDowell Road, Ligonier, PA, 15658, US

(21) Appl. No.: 12/006,037

(22) Filed: Dec. 31, 2007

(51) Int. Cl. A01K 27/00

(52) U.S. Cl. 119/858

(57) ABSTRACT

A UV (ultraviolet light) reflecting cat collar adapted to be carried by a predatory animal is provided. The device reflects light in ultraviolet wavelengths to which many species of bird have a pronounced sensitivity as UV reflectance is strongly involved in mate selection, territorial displays, and foraging for food by many bird species. Therefore, stationary or moving cats wearing the UV reflective collar will be highly visible, during the day and crepuscular periods (i.e., dawn and dusk), to many species of birds that can, in turn, avoid predation by earlier detection of hunting cats and taking evasive action. Predation by domestic cats is a major source of mortality for songbirds and represents a significant conservation threat to many species. Cats killing birds is also a source of concern and distress for many cat owners. Ultraviolet reflecting-fabrics, -materials, or -coatings are either firmly attached to the exterior of a standard cat collar, or the entire collar is made of UV light-reflecting material or covered in UV-reflecting coatings. Different fabrics or coatings that reflect or absorb different wavelengths of ultraviolet light may be arranged in patterns along the collar to enhance visibility to a wide range of bird species with varying sensitivities to different UV wavelengths or contrasting patterns of UV and visible wavelengths. Cats wearing these collars during daylight will be more easily detected by birds that, subsequently, can take evasive action and alert other birds through alarm calls.

### FIELD OF THE INVENTION

The field of the present invention relates to animal husbandry. In particular, an ultraviolet light (UV)-reflecting collar for domestic cats is described herein for deterring bird predation.

### BACKGROUND

### Problem

Domestic cats kill millions of wild birds each year. This predation represents a significant source of mortality for birds around the world, and is a major threat to a number of declining species (Paton 1991, Coleman et al. 1997, Kays & DeWan 2004, Beckerman et al. 2007). Indeed, cat predation has been implicated as a major cause of extinction of numerous species of bird, small mammal, and reptiles (Paton 1991). Over 1.4 billion birds in the United States alone are estimated to be killed or injured by domestic cats each year, and 75 million in the United Kingdom (Coleman et al. 1997, Woods et al. 2003, Lepcyzk et al. 2004). Predation by domestic cats is particularly problematic as domestic cats occur at high densities, their numbers not being controlled by natural factors or territoriality, they are well fed and will thus hunt rare as well as more abundant species, and their hunting instinct is active even if they are well fed (Coleman et al. 1997). Cat predation on birds is also a source of consternation and distress for many pet owners. The invention presented here will enable birds to detect hunting and non-hunting cats more frequently and sooner, which, in turn, will enable the birds to take evasive action and alert other birds through alarm calls. Therefore, the rate of bird kills and bird injury by domestic cats wearing these collars and hunting during the day and crepuscular hours (i.e., dawn and dusk)—when UV light reflectance will be discernible—will be reduced.

The following terms used herein are intended to be interpreted in the manner indicated below:

“Predation” is used here to mean the killing of or injury to prey by the subject animal.

“Subject animal” is an animal, for example, a domestic cat, wearing the device according to the present invention.

“Ultraviolet (UV) fabric, material, or coatings” is used here to mean any material that reflects or light in ultraviolet wavelengths (100 nm [nanometers] to 400 nm, including UV-A, UV-B, and UV-C) including, but not limited to, fabrics, sticker films, waxes, varnishes, or sprays. This ultraviolet fabric, material, or coating may be combined with UV light-absorbing materials or coatings to enhance detectability by certain bird species.

“Emit” is used to here to mean reflecting UV light from reflective material or coatings.

“Reflectances” or “absorbances” are used here to mean the action of an ultraviolet (UV) fabric, material, or coating in reflecting or absorbing UV radiation or light, respectively.

### Mechanism

Bird's eyes are highly sensitive to a range of ultraviolet light (hereafter, UV) wavelengths (100 nanometers [nm] to 400 nm wavelengths). Many bird species are particularly adapted to detecting discrete ultraviolet signatures in their environment (Eaton & Lanyon 2003) as ultraviolet reflectance or absorbance from plumage helps them find conspecifics and assess prospective mates (Bennett et al. 1997, Hunt 1998, Hunt et al. 2001), be aware of the presence and vigor of rivals (Hunt 1998), and avoid spider webs (Buer & Regner 2002). The UV reflectance from fruits (Burkhardt 1982, Willson & Whelan 1989, Church et al. 2001), cryptic invertebrate prey (Church et al. 1998), and rodent urine (Vitala et al. 1995, Buer & Regner 2002) also assists many bird species in locating food, as well as parasitic cuckoo eggs (Aviles et al. 2006). Therefore, birds are keenly aware of, and highly sensitive to, small and discrete sources of ultraviolet light in the environment, and this, coupled with the fact that birds key in on movement to avoid predation (Fernández-Juricic et al. 2004), would make the signature from a UV-reflecting cat collar highly visible and detectable to birds. The common behavior of many bird species in making alarm calls when they detect predators means that if one bird detects a hunting cat then, in many cases, multiple birds will be alerted to the presence of the cat.

The eyes of mammals are unable to detect ultraviolet light wavelengths (Chen et al. 1984). Birds are able to do so as they have a retinal cone—one that is absent in mammals—that is sensitive to UV wavelengths (Burkhardt 1989). Therefore, the desirable function of cats in hunting and killing of vermin and pests, such as mice and rats, which are usually nocturnal anyway, will be undiminished. While nocturnal hunting by cats will not be deterred by these collars, the high sensitivity of birds to even dim UV light means that hunting activity of cats wearing this invention can still be detected by birds during cloudy or crepuscular conditions.

The cat collar presented here would employ materials (e.g., fabrics, woven belts, etc.) or coatings (e.g., sprays, varnishes, flourochromes, etc.) that reflect or absorb light in the ultraviolet wavelengths of 100 nm to 400 nm, a range which includes reflectances documented for many bird plumages, fruits, invertebrate prey, and rodent urine. Birds are able to see ultraviolet in the wavelengths of 100 nm to 400 nm (Chen et al. 1984, Finger & Burkhardt 1994). (Many different fabrics, materials, or coatings that reflect ultraviolet light or absorb ultraviolet light are available commercially). A maximal sensitivity to UV wavelengths around 370 nanometers (near-UV) has been documented by Chen et al. (1984) for retinal cones of 15 species of bird in 10 families. Burkhardt (1989) lists 30 species from 6 bird orders for which UV vision has been documented, some with sensitivities up to 30 times greater than some visible wavelengths (Burkhardt 1992). Different birds are maximally sensitive to different ultraviolet light wavelengths (Buer & Regner 2002, Hausmann et al. 2003). Thus, in order to increase the number of bird species that are able to detect the UV light, or contrasting patterns of UV light and visible light, from the invention, materials or coatings that reflect a wide range of wavelengths, possibly in contrasting patterns of different UV (i.e., 100 nm to 400 nm) and visible wavelengths (i.e., 400 nm to 750 nm), on a single collar may be an optimal configuration and is part of this invention. In addition, different patterns of fabric, materials, or coatings with different UV wavelength reflectances or absorbances may enhance detectability of the collars by birds, and this is an additional configuration consideration of this invention. A narrow range of UV wavelength reflectances or absorbances for a collar may enhance detectability of the collars for a target set of birds and this is also a configuration option.

The present invention has been disclosed above with reference to one presently preferred exemplary embodiment. However, the invention is not be construed as being limited to that which has been specifically described and/or illustrated and various modifications may be made as will be apparent to the person skilled in the art without departing from the scope of the invention as will be defined in the claims.

### LITERATURE CITED

Aviles, J M, J J Soler, T Perez-Contreras, M Soler, and A P. Moller. 2006. Ultraviolet reflectance of great spotted cuckoo eggs and egg discrimination by magpies. Behavioral Ecology 17: 310-314
Beckerman, A P, M Boots, and K. J Gaston. 2007. Urban bird declines and the fear of cats. Animal Conservation 10: 320-325.
Bennett, A T, and I C Cuthill. 1994. Ultraviolet vision in birds: what is its function? Vision Research 34: 1471-1478.
Bennett A T, I C Cuthill, J C Partridge, and K Lunau. 1997. Ultraviolet plumage colors predict mate preferences in starlings. Proceedings of the National Academy of Sciences USA 94: 8618-8621.
Buer, F, and M Regner. 2002. With the ‘spider's web effect’ and UV-absorbing material against bird-death on transparent and reflecting panes. Vogel und Umwelt 13: 31-42.
Burkhardt, D. 1982. Birds, berries and UV. Naturwissenschaften 69: 0028-1042
Burkhardt, D. 1989. Die Welt mit anderen Augen. BIUZ 19: 37-46.
Burkhardt, D, and E. Maier. 1989. The spectral sensitivity of a passerine bird is highest in the UV. Naturwissenschaften 76: 28-1042.
Burkhardt, D. 1992. Ultraviolettsehen bei Vögeln. Naturewissenschaftliche Rundschau 45: 7.
Chen, D M, J S Collins, and T H Goldsmith. 1984. The ultraviolet receptor of bird retinas. Science 225: 337-340.
Church, S C, A S L Merrison, and T M M Chamberlain. 2001. Avian ultraviolet vision and frequency-dependent seed preferences. The Journal of Experimental Biology 204: 2491-2498.
Coleman, J S, Temple, S A, and S R Raven. 1997. Cats and wildlife: A conservation dilemma. American Bird Conservancy, Washington, D.C.
Cuthill, I C, J C Partridge, A T D Bennett, S C Church, N S Hart, and S Hunt. 2000. Ultraviolet vision in birds. Advance in the Study of Behavior 29: 159-214.
Eaton, M D, and S M Lanyon. 2003. The ubiquity of avian ultraviolet plumage reflectance. Proceedings of the Royal Society Biological Sciences 270: 1721-1726.
Fernández-Juricic, E, J T Erichsen, and A Kacelnik. 2004. Visual perception and social foraging in birds. Trends in Ecology & Evolution 19: 25-31.
Finger, E, and D Burkhardt. 1994. Biological aspects of bird colouration and avian colour vision including ultraviolet range. Vision Research 34: 1509-1514.
Gotmark, F, and A Hohlfalt. 1995. Bright male plumage and predation risk in Passerine birds: Are males easier to detect than females? Oikos 74: 475-484
Hausmann F, K E Arnold, N J Marshall N J, and I P Owens. 2003. Ultraviolet signals in birds are special. Proceedings of the Royal Society Biological Sciences 270: 61-67.
Hunt, S, A T D Bennett, I C Cuthill, and R Griffiths. 1998. Blue tits are ultraviolet tits. Proceedings of the Royal Society Biological Sciences 265: 451-455
Hunt, S, I C Cuthill, A T Bennett, S C Church, and J C Partridge. 2001. Is the ultraviolet waveband a special communication channel in avian mate choice? Journal Experimental Biology 204: 2499-2507.
Kays, R W, and A A DeWan. 2004. Ecological impact of inside/outside house cats around a suburban nature preserve. Animal Conservation 7: 273-283
Lepczyk, C A, Mertig, A G, and J. Liu. 2004. Landowners and cat predation across rural-to-urban landscapes. Biological Conservation 115: 191-201.
Mason, C F. 2006. Avian species richness and numbers in the built environment: Can new housing developments be good for birds? Biodiversity and Conservation 15: 8.
Paton, D C. 1991. Loss of wildlife to domestic cats. Pages 64-69 in (C. Potter, editor) Proceedings of a Workshop on the Impact of Cats on Native Wildlife. Endangered Species Unit, Australian Natural Parks and Wildlife Service, Sydney, Australia.
Vitala, J, E Korpimäki, P Palokangas, and M Koivula. 1995. Attraction of kestrels to vole scent marks in ultraviolet light. Nature 373: 425-427.
Willson, M F, and C J Whelan. 1989. Ultraviolet reflectance of fruits of vertebrate-dispersed plants. Oikos 55: 341-348.
Woods, M, R A McDonald, and S Harris. 2003. Predation of wildlife by domestic cats Felis catus in Great Britain. Mammal Review 33: 174-188.

What is claimed is:

1. A cat collar that has ultraviolet light-reflecting fabric, material, or coatings on its exterior (that is, the side away from the subject animal's body) such that birds and other animals sensitive to ultraviolet light will readily detect the presence of the subject animal during diurnal (i.e., day) and crepuscular (i.e., dawn and dusk) periods.

2. A cat collar that utilizes materials or coatings that reflect single or multiple ranges of UV wavelengths using either randomly mixed emitters or purposively arranged patterns of fabric or coatings that reflect or absorb different UV wavelengths.

3. A cat collar comprised either entirely of an ultraviolet light reflecting material, or of material suitable for cat collars with UV light reflecting material or coatings attached to the exterior, according to claim 1 and 2.

4. A cat collar that has ultraviolet light reflecting material on its exterior according to claim 1, 2, and 3 that reflects ultraviolet light in the wavelengths of 100 nm to 400 nm, and which, in some cases, may have portions of the collar comprised of materials or coatings that absorb UV light in the wavelengths of 100 nm to 400 nm.

5. A cat collar comprised of the features according to claims 1-4 that is designed to be worn by domestic cats and is designed appropriately in terms of the collar length, width, flexibility, attachment, and health and safety features for these subject animals.
